(19) United States
(12) Patent Application Publication
(10) Pub. No.: US 2023/0029810 A1
(43) Pub. Date: Feb. 2, 2023

(54) BATTERY MODEL CONSTRUCTION METHOD AND BATTERY DEGRADATION PREDICTION DEVICE

(71) Applicant: HONDA MOTOR CO., LTD., Tokyo (JP)

(72) Inventors: Shunsuke KONISHI, Saitama (JP); Takuma KAWAHARA, Saitama (JP); Hidetoshi UTSUMI, Saitama (JP); Hodaka TSUGE, Saitama (JP); Seiichi KOKETSU, Saitama (JP)

(21) Appl. No.: 17/815,203

(22) Filed: Jul. 26, 2022

(30) Foreign Application Priority Data
Jul. 27, 2021 (JP) 2021-122309

(51) Int. Cl. G01R 31/367; G06F 30/27; G01R 31/392

(52) U.S. Cl. CPC G01R 31/367; G06F 30/27; G01R 31/392

(57) ABSTRACT

A battery model construction method is a method for constructing a battery model that treats powers of a plurality of usage history parameters defined on a basis of time series data about a current, a voltage, and a temperature of a battery as explanatory variables and treats a predicted SOH value as an objective variable, the method including: an acquiring step ST1 for acquiring time series data of usage history parameters and measured SOH values; an exponentiating step ST2 for raising the usage history parameters by a prescribed exponent to thereby generate time series data of input parameters; a training step ST4 for training the battery model by using the time series data of the input parameters and the measured SOH values as training data; and a searching step ST8 for searching for an optimal exponent by repeatedly performing the steps ST2 and ST4 while varying the exponent.

This application is based on and claims the benefit of priority from Japanese Patent Application No. 2021-122309, filed on 27 Jul. 2021, the content of which is incorporated herein by reference.

### BACKGROUND OF THE INVENTION

### Field of the Invention

The present disclosure relates to a battery model construction method and a battery degradation prediction device. More particularly, the present disclosure relates to a battery model construction method for constructing a battery model for calculating a predicted value of a battery degradation indicator, and a battery degradation prediction device that calculates a predicted value of a battery degradation indicator according to a battery model constructed according to the battery model construction method.

### Related Art

Secondary batteries installed in electric vehicles, hybrid vehicles, and the like have the property of degrading with use. A secondary battery that is degraded is no longer capable of exhibiting adequate performance, and consequently it is necessary to slow the progress of degradation by taking appropriate measures according to how far the degradation has progressed. In addition, taking such measures for slowing the progress of degradation necessitates the accurate estimation of the degree of degradation in a secondary battery. For example, Patent Document 1 discloses a technology for estimating the degree of degradation in a secondary battery on the basis of data (such as changes in the current, voltage, and temperature of the secondary battery and the lifetime to date, for example) that indicates how the secondary battery has been used.

Additionally, with regard to a battery model that estimates the degree of degradation in a secondary battery from data about how the secondary battery has been used, various methods other than a method using a linear regression model have been proposed, such as methods using a neural network, a gradient-boosted decision tree (hereinafter abbreviated as “GBDT”), or the like.
Patent Document 1: PCT International Publication No. WO2020/044713

### SUMMARY OF THE INVENTION

It is known that methods based on a neural network or a GBDT can be used to construct a battery model with higher prediction accuracy than methods based on a linear regression model. However, since battery models constructed on the basis of a neural network or a GBDT are more complex compared to a linear regression model, model construction is time-consuming and the influence of each factor is difficult to grasp. Moreover, a degradation trend of a secondary battery is generally nonlinear, making it difficult to construct a battery model with high prediction accuracy from a simple linear regression model.

An objective of the present disclosure is to provide a battery model construction method and a battery degradation prediction device that can accurately predict battery degradation while retaining a simple structure.

(1) A battery model construction method according to the present disclosure is a method for constructing a battery model that treats powers of a plurality of usage history parameters defined on a basis of time series data about a current, a voltage, and a temperature of a battery as explanatory variables and treats a predicted value of a degradation indicator for the battery as an objective variable, the battery model construction method including: an acquiring step of acquiring time series data about the usage history parameters and the degradation indicator (for example, an acquiring step ST1 described later); an exponentiating step of raising the usage history parameters by a prescribed exponent (for example, exponents z, xv, xt, xi described later) to thereby generate time series data of input parameters (for example, an exponentiating step ST2 described later); a training step of training the battery model by using the time series data of the input parameters and the degradation indicator as training data (for example, a training step ST4 described later); and a searching step of searching for an optimal exponent (for example, optimal exponents x_opt, xv_opt, xt_opt, xi_opt described later) by repeatedly performing the exponentiating step and the training step while varying the exponent (for example, a searching step ST8 described later).

(2) In this case, preferably, the battery model is a linear regression model expressing the objective variable as a linear function of the explanatory variables.

(3) In this case, preferably, the usage history parameters include current factor parameters that treat the current of the battery as a factor, voltage factor parameters that treat the voltage of the battery as a factor, and temperature factor parameters that treat the temperature of the battery as a factor.

(4) In this case, preferably, the searching step includes searching for an optimal exponent (for example, an optimal exponent x_opt described later) common to the current factor parameters, the voltage factor parameters, and the temperature factor parameters.

(5) In this case, preferably, the searching step includes searching for respectively independent optimal exponents (for example, optimal exponents zi_opt, zv_opt, zt_opt described later) for the current factor parameters, the voltage factor parameters, and the temperature factor parameters.

(6) In this case, preferably, the searching step includes searching for the optimal exponent in a range from 0 to 1.

(7) In this case, preferably, in the training step, a portion of the time series data of the input parameters and the degradation indicator that belongs to a prescribed training period is treated as the training data, and in the searching step, a portion of the time series data of the input parameters and the degradation indicator that belongs to a verification period subsequent to the training period is treated as verification data, and the optimal exponent is found by evaluating a prediction accuracy of the battery model trained using the verification data.

(8) A battery degradation prediction device (for example, a battery degradation prediction device 1 described later) according to the present disclosure calculates a predicted value of a degradation indicator for a battery according to a battery model that treats powers of a plurality of usage history parameters defined on a basis of time series data about a current, a voltage, and a temperature of the battery as explanatory variables and treats the predicted value of the battery degradation indicator as an objective variable, the battery degradation prediction device including: a data acquirer (for example, a data acquirer 11 described later) that acquires time series data about a current, a voltage, and a temperature of the battery; a usage history parameter calculator (for example, a usage history parameter calculator 12 described later) that calculates the usage history parameters on a basis of the time series data acquired by the data acquirer; an input parameter generator (for example, an input parameter generator 13 described later) that generates input parameters by raising the usage history parameters by an optimal exponent found by searching according to the battery model construction method according to any of (1) to (7); and a model predictor (for example, a model predictor 14 described later) that calculates the predicted value of the degradation indicator by inputting the input parameters into the battery model as explanatory variables, wherein the battery model is trained with training data generated through exponentiation using the optimal exponent.

(1) The battery model construction method according to the present disclosure is used to construct a battery model that treats powers of a plurality of usage history parameters defined on a basis of time series data about a current, a voltage, and a temperature of a battery as explanatory variables, treats a predicted value of a degradation indicator for the battery as the objective variable, and associates the explanatory variables with the objective variable. According to the present disclosure, by defining the explanatory variables of the battery model as powers of the usage history parameters, nonlinearity in the degradation trend of the battery can be reproduced. As a rule of thumb regarding the degradation trend in lithium-ion batteries, it is known that the capacity degradation follows a linear relationship with the 0.5th power of the elapsed time, number of charge-discharge cycles, or the like, also referred to as the square root law. However, this square root law is ultimately a mere rule of thumb, and there is no basis for concluding that the optimal exponent is 0.5 for all types of batteries. In this regard, in the present disclosure, by executing an exponentiating step that generates time series data of the input parameters by raising the usage history parameters by a prescribed exponent, a training step that trains a battery model by treating the time series data of the input parameters and the degradation indicator as training data, and a searching step that searches for an optimal exponent by repeatedly executing the exponentiating step and the training step while varying the exponent, an optimal exponent corresponding to the characteristics of the battery that the battery model attempts to reproduce can be found. Moreover, according to the present disclosure, by training the battery model using training data generated through exponentiation based on the optimal exponent found in this way, a battery model that can accurately predict battery degradation while retaining a simple structure can be constructed.

(2) According to the present disclosure, by taking the battery model that treats powers of a plurality of usage history parameters as explanatory variables to be a linear regression model that expresses the objective variable as a linear function of the explanatory variables, a battery model that can accurately predict battery degradation while retaining a simple structure can be constructed.

(3) In the present disclosure, by taking the usage history parameters to be current factor parameters that treat the current of the battery as a factor, voltage factor parameters that treat the voltage of the battery as a factor, and temperature factor parameters that treat the temperature of the battery as a factor, battery degradation can be predicted with high accuracy according to the usage form of the battery and the usage environment.

(4) In the present disclosure, by searching for an optimal exponent common to the current factor parameters, the voltage factor parameters, and the temperature factor parameters in the searching step, an optimal exponent can be determined with a simple procedure.

(5) In the present disclosure, by searching for respectively independent optimal exponents for the current factor parameters, the voltage factor parameters, and the temperature factor parameters in the searching step, a battery model that can accurately predict battery degradation can be constructed.

(6) In the present disclosure, by searching for an optimal exponent in the range from 0 to 1 in the searching step, an optimal exponent near the exponent of 0.5 derived empirically according to the above square root law can be found.

(7) In the present disclosure, in the training step, a portion of the time series data of the input parameters and the degradation indicator that belongs to a prescribed training period is treated as the training data. Also, in the searching step, the portion of the time series data of the input parameters and the degradation indicator that belongs to a verification period subsequent to the training period is treated as verification data, and the optimal exponent is found by evaluating the prediction accuracy of a battery model trained using the verification data. According to the present disclosure, by training the battery model using training data generated through exponentiation based on the optimal exponent found according to such a procedure, a battery model that can make accurate predictions with respect to unknown data can be constructed.

(8) The battery degradation prediction device according to the present disclosure includes: a data acquirer that acquires time series data about a current, a voltage, and a temperature of the battery; a usage history parameter calculator that calculates the usage history parameters on a basis of the time series data acquired by the data acquirer; an input parameter generator that generates input parameters by raising the usage history parameters by an optimal exponent; and a model predictor that calculates the predicted value of the degradation indicator for the battery by inputting the input parameters into the battery model as explanatory variables. Also, in the present disclosure, a battery model trained with training data generated through exponentiation using the optimal exponent found according to the above battery model construction method is used. According to the present disclosure, the degradation trend of a battery currently in use can be predicted accurately.

### BRIEF DESCRIPTION OF THE DRAWINGS

FIG. 1 is a diagram illustrating a configuration of a battery degradation prediction device according to an embodiment of the present disclosure;

FIG. 2 is a diagram schematically illustrating a configuration of a plurality of usage history parameters;

FIG. 3 is a flowchart illustrating a specific procedure of a battery model construction method;

FIG. 4A is a diagram illustrating prediction results from a battery model according to comparative example 1;

FIG. 4B is a diagram illustrating prediction results from a battery model according to comparative example 2;

FIG. 4C is a diagram illustrating prediction results from a battery model according to comparative example 3;

FIG. 4D is a diagram illustrating prediction results from a battery model according to example 1;

FIG. 4E is a diagram illustrating prediction results from a battery model according to example 2; and

FIG. 5 is a table summarizing prediction accuracy indicators for comparative examples 1 to 3 and examples 1 and 2.

### DETAILED DESCRIPTION OF THE INVENTION

Hereinafter, a battery degradation prediction device according to an embodiment of the present disclosure and a method for constructing a battery model used in the battery degradation prediction device will be described with reference to the drawings.

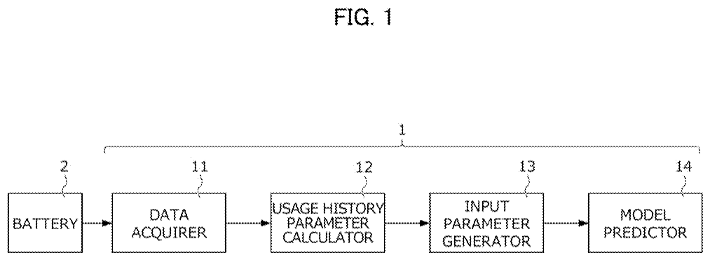

FIG. 1 is a diagram illustrating a configuration of a battery degradation prediction device 1 according to the embodiment. The battery degradation prediction device 1 predicts the degree of degradation in a battery 2 on the basis of time series data about the current, voltage, and temperature of the battery 2. Hereinafter, a case will be described in which the battery degradation prediction device 1 is installed in an electric vehicle (not illustrated) that is driven using electric power from the battery 2 and predicts the degree of degradation in the battery 2 onboard the electric vehicle, but the present disclosure is not limited to the above. Some or all of the components of the battery degradation prediction device 1 may also be implemented by a server communicably connected to the electric vehicle.

The battery 2 is a secondary battery that can both be discharged, in which chemical energy is converted into electrical energy, and be charged, in which electrical energy is converted into chemical energy. The following describes a case where a battery that is charged and discharged by the movement of lithium ions between electrodes, commonly referred to as a lithium-ion battery, is used as the battery 2, but the present disclosure is not limited thereto. The battery 2 is connected to an electrical load (not illustrated) including an inverter, drive motor, and the like, and is charged and discharged with respect to the electrical load.

The battery degradation prediction device 1 is a computer implemented by hardware including, for instance, a computational processor such as a CPU, secondary storage such as an HDD or an SSD storing various programs, and primary storage such as RAM for storing data temporarily need in the execution of the programs by the computational processor. With a hardware configuration like the above, various functions such as a data acquirer 11, a usage history parameter calculator 12, an input parameter generator 13, and a model predictor 14 are achieved in the battery degradation prediction device 1.

The data acquirer 11 acquires time series data about the current, voltage, and temperature of the battery 2 on the basis of the output from a battery sensor (not illustrated) provided in the battery 2.

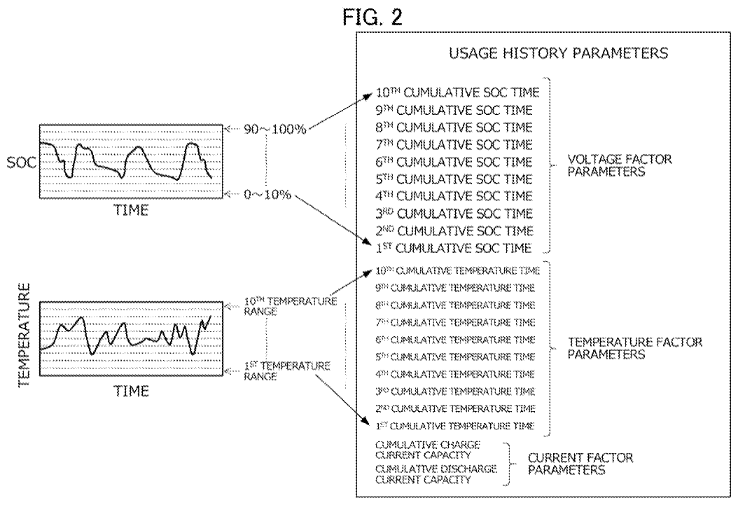

The usage history parameter calculator 12 calculates, on a prescribed period, a plurality of usage history parameters expressing how the battery 2 has been used on the basis of the time series data about the current, voltage, and temperature acquired by the data acquirer 11, and inputs the usage history parameters into the input parameter generator 13. The following describes a case where the calculation period for the usage history parameters in the usage history parameter calculator 12 is set to two weeks, but the present disclosure is not limited thereto. FIG. 2 is a diagram schematically illustrating the configuration of the plurality of usage history parameters calculated in the usage history parameter calculator 12. As illustrated in FIG. 2, the plurality of usage history parameters calculated in the usage history parameter calculator 12 include a plurality of voltage factor parameters, a plurality of temperature factor parameters, and a plurality of current factor parameters.

A voltage factor parameter refers to a parameter that treats the voltage of the battery 2 as a factor. In other words, a voltage factor parameter is a parameter most highly correlated with voltage from among the current, voltage, and temperature of the battery 2. In the present embodiment, the integral values of the time spent within a prescribed range of the state of charge (SOC), which is approximately proportional to the discharge voltage of the battery 2, are defined as the voltage factor parameters. More specifically, a first cumulative SOC time is the integral value of the time that the SOC of the battery 2 has spent in the range from 0 to 10 [%], a second cumulative SOC time is the integral value of the time that the SOC of the battery 2 has spent in the range from 10 to 20 [%]: a third cumulative SOC time is the integral value of the time that the SOC of the battery 2 has spent in the range from 20 to 30 [%], a fourth cumulative SOC time is the integral value of the time that the SOC of the battery 2 has spent in the range from 30 to 40 [%], a fifth cumulative SOC time is the integral value of the time that the SOC of the battery 2 has spent in the range from 40 to 50 [%], a sixth cumulative SOC time is the integral value of the time that the SOC of the battery 2 has spent in the range from 50 to 60 [%], a seventh cumulative SOC time is the integral value of the time that the SOC of the battery 2 has spent in the range from 60 to 70 [%]1, an eighth cumulative SOC time is the integral value of the time that the SOC of the battery 2 has spent in the range from 70 to 80 [%], a ninth cumulative SOC time is the integral value of the time that the SOC of the battery 2 has spent in the range from 80 to 90 [%], and a tenth cumulative SOC time is the integral value of the time that the SOC of the battery 2 has spent in the range from 90 to 100 [%].

A temperature factor parameter refers to a parameter that treats the temperature of the battery 2 as a factor. In other words, a temperature factor parameter is a parameter most highly correlated with temperature from among the current, voltage, and temperature of the battery 2. In the present embodiment, the operating temperature range of the battery 2 is divided into 10 equal ranges, and the integral values of the time that the temperature of the battery 2 spends within each of the temperature ranges are defined as the temperature factor parameters. More specifically, a first cumulative temperature time is the integral value of the time that the temperature of the battery 2 has spent in the first temperature range, a second cumulative temperature time is the integral value of the time that the temperature of the battery 2 has spent in the second temperature range, the second temperature range being higher than the first temperature range, a third cumulative temperature time is the integral value of the time that the temperature of the battery 2 has spent in the third temperature range, the third temperature range being higher than the second temperature range, a fourth cumulative temperature time is the integral value of the time that the temperature of the battery 2 has spent in the fourth temperature range, the fourth temperature range being higher than the third temperature range, a fifth cumulative temperature time is the integral value of the time that the temperature of the battery 2 has spent in the fifth temperature range, the fifth temperature range being higher than the fourth temperature range, a sixth cumulative temperature time is the integral value of the time that the temperature of the battery 2 has spent in the sixth temperature range, the sixth temperature range being higher than the fifth temperature range, a seventh cumulative temperature time is the integral value of the time that the temperature of the battery 2 has spent in the seventh temperature range, the seventh temperature range being higher than the sixth temperature range, an eighth cumulative temperature time is the integral value of the time that the temperature of the battery 2 has spent in the eighth temperature range, the eighth temperature range being higher than the seventh temperature range, a ninth cumulative temperature time is the integral value of the time that the temperature of the battery 2 has spent in the ninth temperature range, the ninth temperature range being higher than the eighth temperature range, and a tenth cumulative temperature time is the integral value of the time that the temperature of the battery 2 has spent in the tenth temperature range, the tenth temperature range being higher than the ninth temperature range.

A current factor parameter refers to a parameter that treats the current of the battery 2 as a factor. In other words, a current factor parameter is a parameter most highly correlated with current from among the current, voltage, and temperature of the battery 2. In the present embodiment, the cumulative charge current capacity, which is the integral value of the product of the charge current of the battery 2 and the time, and the cumulative discharge current capacity, which is the integral value of the product of the discharge current of the battery 2 and the time, are defined as the current factor parameters. As above, the present embodiment describes a case where integral values of the product of the current and time are defined as the current factor parameters, but the present disclosure is not limited thereto. For example, the number of charge-discharge cycles, which corresponds to the number of times the battery 2 has switched between charging and discharging, may also be defined as a current factor parameter.

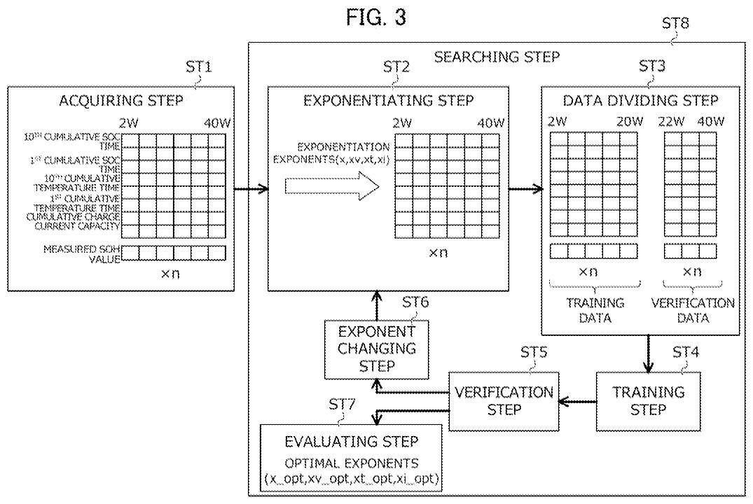

Returning to FIG. 1, the input parameter generator 13 generates a plurality of input parameters by raising the plurality of usage history parameters calculated on a prescribed period from the usage history parameter calculator 12 by a predetermined optimal exponent, and inputs the generated input parameters into the model predictor 14. Here, the optimal exponent is determined as a value in the range from 0 to 1 according to a battery model construction method described later with reference to FIG. 3. Note that the optimal exponent referenced in the exponentiation by the input parameter generator 13 may be a common exponent for all of the usage history parameters (see example 1 described later) or a different exponent for the current factor parameters, the voltage factor parameters, and the temperature factor parameters (see example 2 described later).

The model predictor 14 includes a battery model that treats powers of the plurality of usage history parameters of the battery 2 as explanatory variables and treats a predicted value of a degradation indicator for the battery 2 as the objective variable, and calculates the predicted value of the degradation indicator for the battery 2 by inputting the plurality of input parameters generated by the input parameter generator 13 into the above battery model as the explanatory variables. The present embodiment describes a case where the state of health (SOH), which indicates the ratio of the full charge capacity [Ah] in the degraded state relative to the initial full charge capacity of the battery 2 defined as 100%, is used as the degradation indicator for the battery 2, but the present disclosure is not limited thereto. A model constructed according to the battery model construction method described later with reference to FIG. 3, namely a linear regression model in which the objective variable is expressed as a linear function of a plurality of explanatory variables, is used for the battery model here. More specifically, a linear regression model that has been trained with training data generated through exponentiation using the optimal exponent described above is used for the battery model.

Next, a method by which a computer constructs the battery model that treats powers of the plurality of usage history parameters of the battery 2 as explanatory variables, treats a predicted value of a degradation indicator for the battery 2 as the objective variable, and expresses the objective variable as a linear function of the plurality of explanatory variables as above will be described.

FIG. 3 is a flowchart schematically illustrating a procedure of the battery model construction method according to the present embodiment.

First, in an acquiring step ST1, the designer of the battery model acquires n sets (where n is an integer equal to or greater than 2) of time series data over a prescribed sample period (for example, 40 weeks) of measured values of the plurality of usage history parameters and the SOH for sample batteries of the same type as the battery 2 described with reference to FIG. 1.

Next, in a searching step ST8, an exponentiating step ST2, a data dividing step ST3, a training step ST4, a verifying step ST5, and an exponent changing step ST6 are repeated multiple times, after which an evaluating step ST7 is performed. Hereinafter, the content of each step from ST2 to ST7 will be described in detail.

First, in the exponentiating step ST2, the designer raises the plurality of usage history parameters acquired in the acquiring step ST1 by a prescribed exponent to thereby generate time series data of the plurality of input parameters. Note that in the exponentiating step ST2, a common exponent x may be defined for the plurality of usage history parameters, or an exponent xv, an exponent xt, and an exponent xi may be defined independently for the voltage factor parameters, the temperature factor parameters, and the current factor parameters, respectively. Also, the initial values of the exponents (x, xv, xt, xi) are set to any real number in the range from 0 to 1 (for example, 0.5).

Next, in the data dividing step ST3, from among the time series data over the sample period of the measured values of the plurality of input parameters and the SOH generated in steps ST1 and ST2 above, the designer defines training data to be the data belonging to a training period (from week 2 to week 20, for example) and defines verification data to be the data belonging to a verification period (from week 22 to week 40, for example) subsequent to the training period.

Next, in the training step ST4, the designer constructs a battery model by using the training data defined in the above step ST3 to train a linear regression model that treats the plurality of input parameters as explanatory variables and treats a predicted SOH value as the objective variable, and stores the battery model in association with the exponent(s) set in step ST2 in a storage medium.

Next, in the verifying step ST5, the design uses the verification data defined in step ST3 to evaluate the prediction accuracy of the trained battery model that was constructed in step ST4. More specifically, the prediction accuracy of the trained battery model is evaluated by comparing the predicted SOH value obtained by inputting the input parameters included in the verification data into the trained battery model as explanatory variables to the measured SOH value included in the verification data. The present embodiment describes a case where values such as the mean absolute error (hereinafter, the abbreviation “MAE” will be used), the root mean square error (hereinafter, the abbreviation “RMSE” will be used), and the coefficient of determination (hereinafter, the abbreviation “R” will be used) between the predicted SOH value and the measured SOH value are treated as prediction accuracy indicators for the trained battery model.

Next, in the exponent changing step ST6, the designer changes the exponent(s) defined in the exponentiating step ST2 to a value that is in the range from 0 to 1 and also different from previously set values, and then returns to the exponentiating step ST2. At this point, if a common exponent x is defined for the plurality of usage history parameters as described above, only the common exponent x is changed, whereas if exponents (xv, xt, zi) are defined independently for each of the factor parameters, at least one of the exponents (xv, xt, xi) is changed.

In the searching step ST8, steps ST2 to ST6 are repeated multiple times while varying the exponents (x, xv, xt, xi) as described above to thereby enable a plurality of sets of exponents (x, xv, xt, xi), a plurality of sets of trained battery models associated with the exponents, and prediction accuracy indicators with respect to each of the trained battery models to be obtained.

Next, in the evaluating step ST7, the designer searches for an optimal exponent x_opt for the common exponent x or optimal exponents (zv_opt, zt_opt, zi_opt) for the exponents (xv, xt, xi) defined for each of the factor parameters, on the basis of the plurality of prediction accuracy indicators calculated in steps ST2 to ST6. More specifically, in the evaluating step ST7, the designer determines the trained battery model with the highest prediction accuracy on the basis of the calculation results regarding the prediction accuracy indicators, and determines the exponents associated with this trained battery model as the optimal exponents (x_opt, xv_opt, xt_opt, xi_opt).

Next, the prediction accuracy of the battery models in examples 1 and 2 constructed on the basis of the battery model construction method as described above will be compared to the prediction accuracy of battery models in comparative examples 1 to 3.

### Comparative Example 1

Comparative example 1 is a battery model constructed on the basis of a GBDT. More specifically, comparative example 1 is taken to be a battery model constructed on the basis of a GBDT given the time series data over the training period of the measured values of the usage history parameters and the SOH acquired in the acquiring step ST1 as training data.

### Comparative Example 2

Comparative example 2 is a linear regression model that treats a plurality of usage history parameters as explanatory variables and treats a predicted SOH value of a battery as the objective variable. More specifically, comparative example 2 is taken to be a linear regression model trained using the same training data as comparative example 1.

### Comparative Example 3

Comparative example 3 is a linear regression model that treats powers of a plurality of usage history parameters as explanatory variables and treats a predicted SOH value of a battery as the objective variable. More specifically, comparative example 3 is taken to be a linear regression model trained using the training data derived according to steps ST1 to ST3 by defining a common exponent x with respect to the factor parameters and setting the common exponent to an initial value of 0.5.

### Example 1

Example 1 is a linear regression model that treats powers of a plurality of usage history parameters as explanatory variables and treats a predicted SOH value of a battery as the objective variable, and is a battery model constructed in accordance with the battery model construction model illustrated in FIG. 3. More specifically, example 1 is taken to be a trained battery model associated with the optimal exponent x_opt found by searching for the optimal exponent x_opt for the common exponent x with respect to the factor parameters in accordance with the procedure illustrated in FIG. 3. In other words, example 1 is a linear regression model trained using training data generated through exponentiation by the optimal exponent x_opt. Note that in this case, the optimal exponent x_opt was 0.71.

### Example 2

Example 2 is a linear regression model that treats powers of a plurality of usage history parameters as explanatory variables and treats a predicted SOH value of a battery as the objective variable, and is a battery model constructed in accordance with the battery model construction method illustrated in FIG. 3. More specifically, example 2 is taken to be a trained battery model associated with the optimal exponents (xv_opt, xt_opt, xi_opt) found by searching for the optimal exponents (xv_opt, xt_opt, xi_opt) for the exponents (xv, xt, xi) defined independently with respect to each of the factor parameters in accordance with the procedure illustrated in FIG. 3. In other words, example 2 is a linear regression model trained using training data generated through exponentiation by the optimal exponents (xv_opt, xt_opt, xi_opt). In this case, the optimal exponent xv_opt for the voltage factor parameters was 0.87, the optimal exponent xt_opt for the temperature factor parameters was 0.67, and the optimal exponent xi_opt for the current factor parameters was 0.66. Note that the linear regression models in comparative examples 2 and 3 and examples 1 and 2 have the same functional form.

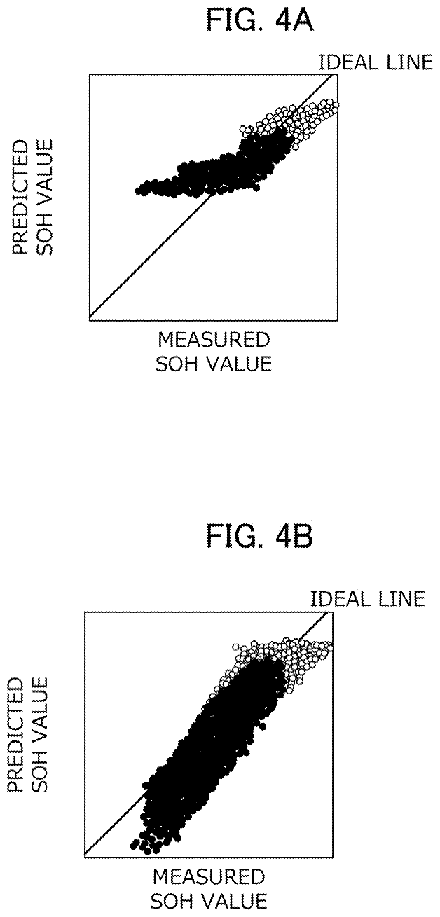

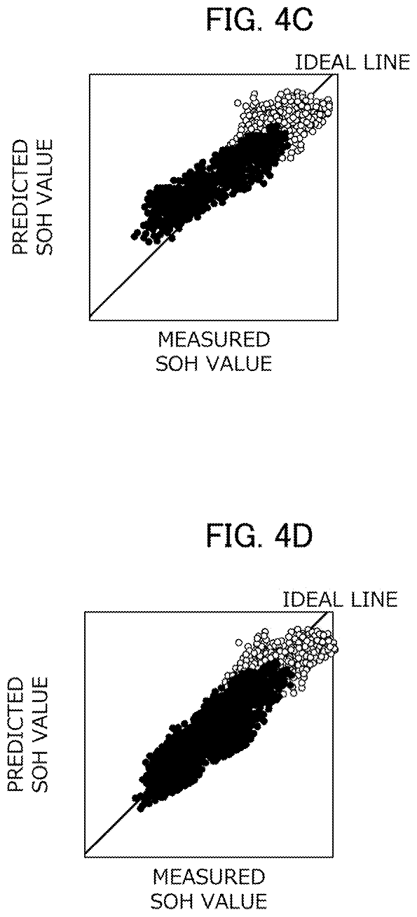

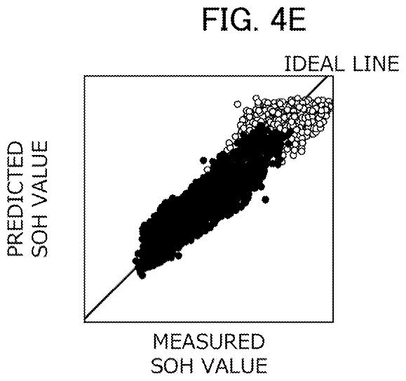

FIGS. 4A to 4E are diagrams illustrating prediction results from the battery models according to comparative examples 1, 2, and 3 and examples 1 and 2, respectively. In FIGS. 4A to 4E, the horizontal axis is taken to be the measured SOH value and the vertical axis is taken to be the predicted SOH value obtained by inputting the parameters associated with the measured SOH value into each battery model. Also, the “ideal line” in FIGS. 4A to 4E is the line on which the measured and predicted SOH values are equal. Also, in FIGS. 4A to 4E, the points indicated by white circles are points plotting the prediction results from each battery model in the case where the training data belonging to the training period described above is inputted, whereas the points indicated by black circles are the points plotting the prediction results from each battery model in the case where the verification data belonging the verification period are inputted.

As illustrated in FIGS. 4A to 4E, the prediction results according to examples 1 and 2 are distributed at positions closer to the ideal line than comparative examples 1 to 3. Moreover, the difference in the variation from the ideal line between the points indicated by white circles and the points indicated by black circles is smaller in examples 1 and 2 compared to comparative examples 1 to 3. This means that the difference between the prediction accuracy with respect to known training data and the prediction accuracy with respect to unknown verification data is smaller in examples 1 and 2 compared to comparative examples 1 to 3.

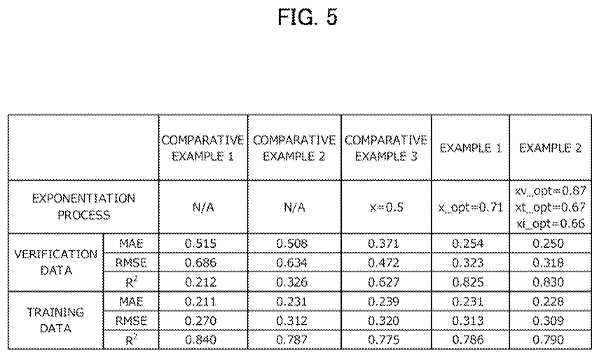

FIG. 5 is a table summarizing prediction accuracy indicators (MAE, RMSE, R²) for comparative examples 1 to 3 and examples 1 and 2. Note that in FIG. 5, the prediction accuracy indicators calculated using the verification data are indicated in the upper rows, while the prediction accuracy indicators calculated using the training data are indicated in the lower rows.

As illustrated in FIG. 5, the MAE, RMSE, and R² calculated using the training data do not differ greatly among comparative examples 1 to 3 and examples 1 and 2. Consequently, the prediction accuracy with respect to known input is not considered to differ greatly among comparative examples 1 to 3 and examples 1 and 2.

In contrast, the MAE and RMSE calculated using the verification data are smaller in examples 1 and 2 compared to comparative examples 1 to 3, while the R² calculated using the verification data is larger in examples 1 and 2 compared to comparative examples 1 to 3. Consequently, compared to comparative examples 1 to 3, the prediction accuracy with respect to unknown input is considered to be higher in examples 1 and 2, in which the exponents are obtained through optimization.

Also, as illustrated in FIG. 5, the MAE and RMSE calculated using the verification data are smaller in example 2 compared to example 1, while the R² calculated using the verification data is larger in example 2 compared to example 1. Consequently, compared to example 1, the prediction accuracy with respect to unknown input is considered to be higher in example 2, in which the exponents are obtained through optimization for each of the factor parameters.

Also, as illustrated in FIG. 5, the difference between the MAE, RMSE, and R² calculated using the verification data and the MAE, RMSE, and R² calculated using the training data is smaller in examples 1 and 2 compared to comparative examples 1 to 3. Accordingly, examples 1 and 2 are considered to be able to maintain prediction accuracy for all kinds of inputs.

According to the battery model construction method and battery degradation prediction device 1 according to the present embodiment, the following effects are achieved.

(1) The battery model construction method according to the present embodiment is used to construct a battery model that treats powers of a plurality of usage history parameters defined on a basis of time series data about a current, a voltage, and a temperature of a battery as explanatory variables, treats a predicted value of a degradation indicator for the battery as the objective variable, and associates the explanatory variables with the objective variable. According to the present embodiment, by defining the explanatory variables of the battery model as powers of the usage history parameters, nonlinearity in the degradation trend of the battery can be reproduced. Also, in the present embodiment, by executing the exponentiating step ST2 that generates time series data of the input parameters by raising the usage history parameters by a prescribed exponent, the training step ST4 that trains the battery model by treating the time series data of the input parameters and the measured SOH values as training data, and the searching step ST2 that searches for an optimal exponent by repeatedly executing the exponentiating step ST2 and the training step ST4 while varying the exponent, an optimal exponent corresponding to the characteristics of the battery that the battery model attempts to reproduce can be found. Moreover, according to the present embodiment, by training the battery model using training data generated through exponentiation based on the optimal exponent found in this way, a battery model that can accurately predict battery degradation while retaining a simple structure can be constructed.

(2) According to the present embodiment, by taking the battery model that treats powers of a plurality of usage history parameters as explanatory variables to be a linear regression model that expresses the objective variable as a linear function of the explanatory variables, a battery model that can accurately predict battery degradation while retaining a simple structure can be constructed.

(3) In the present embodiment, by taking the usage history parameters to be current factor parameters that treat the current of the battery as a factor, voltage factor parameters that treat the voltage of the battery as a factor, and temperature factor parameters that treat the temperature of the battery as a factor, battery degradation can be predicted with high accuracy according to the usage form of the battery and the usage environment.

(4) In the present embodiment, by searching for the optimal exponent x_opt common to the current factor parameters, the voltage factor parameters, and the temperature factor parameters in the searching step ST5, the optimal exponent x_opt can be determined with a simple procedure.

(5) In the present embodiment, by searching for respectively independent optimal exponents (xi_opt, xv_opt, xt_opt) for the current factor parameters, the voltage factor parameters, and the temperature factor parameters in the searching step ST8, a battery model that can accurately predict battery degradation can be constructed.

(6) In the present embodiment, by searching for an optimal exponent in the range from 0 to 1 in the searching step ST8, an optimal exponent near the exponent of 0.5 derived empirically according to the above square root law can be found.

(7) In the present embodiment, in the training step ST3, a portion of the time series data of the input parameters and the measured SOH values that belongs to a prescribed training period is treated as the training data. Also, in the searching step ST8, the portion of the time series data of the input parameters and the measured SOH values that belongs to a verification period subsequent to the training period is treated as verification data, and the optimal exponent is found by evaluating the prediction accuracy of a battery model trained using the verification data. According to the present embodiment, by training the battery model using training data generated through exponentiation based on the optimal exponent found according to such a procedure, a battery model that can make accurate predictions with respect to unknown data can be constructed.

(8) The battery degradation prediction device 1 according to the present embodiment includes: the data acquirer 11 that acquires time series data about a current, a voltage, and a temperature of the battery 2; the usage history parameter calculator 12 that calculates the usage history parameters on a basis of the time series data acquired by the data acquirer 11; the input parameter generator 13 that generates input parameters by raising the usage history parameters by an optimal exponent; and the model predictor 14 that calculates the predicted SOH value of the battery by inputting the input parameters into the battery model as explanatory variables. Also, in the present embodiment, a battery model trained with training data generated through exponentiation using the optimal exponent found according to the above battery model construction method is used. According to the present embodiment, the degradation trend of the battery 2 currently in use can be predicted accurately.

The foregoing describes an embodiment of the present disclosure, but the present disclosure is not limited thereto. The particulars of the configuration may be modified as appropriate within the scope of the present disclosure.

For example, the embodiment above assumes that the rate of battery degradation will slow down gradually in many cases and describes a case of searching for an optimal exponent in the range from 0 to 1, but the present disclosure is not limited thereto. For example, in cases where battery degradation accelerates, that is, in cases where the rate of battery degradation speeds up gradually, it is also possible to search for an optimal exponent in the range from 1 to 3.

What is claimed is:

1. A battery model construction method for constructing a battery model that treats powers of a plurality of usage history parameters defined on a basis of time series data about a current, a voltage, and a temperature of a battery as explanatory variables and treats a predicted value of a degradation indicator for the battery as an objective variable, the battery model construction method comprising:
an acquiring step of acquiring time series data about the usage history parameters and the degradation indicator;
an exponentiating step of raising the usage history parameters by a prescribed exponent to thereby generate time series data of input parameters;
a training step of training the battery model by using the time series data of the input parameters and the degradation indicator as training data; and
a searching step of searching for an optimal exponent by repeatedly performing the exponentiating step and the training step while varying the exponent.

2. The battery model construction method according to claim 1, wherein the battery model is a linear regression model expressing the objective variable as a linear function of the explanatory variables.

3. The battery model construction method according to claim 1, wherein the usage history parameters include current factor parameters that treat the current of the battery as a factor, voltage factor parameters that treat the voltage of the battery as a factor, and temperature factor parameters that treat the temperature of the battery as a factor.

4. The battery model construction method according to claim 3, wherein the searching step comprises searching for an optimal exponent common to the current factor parameters, the voltage factor parameters, and the temperature factor parameters.

5. The battery model construction method according to claim 3, wherein the searching step comprises searching for respectively independent optimal exponents for the current factor parameters, the voltage factor parameters, and the temperature factor parameters.

6. The battery model construction method according to claim 1, wherein the searching step comprises searching for the optimal exponent in a range from 0 to 1.

7. The battery model construction method according to claim 1, wherein in the training step, a portion of the time series data of the input parameters and the degradation indicator that belongs to a prescribed training period is treated as the training data, and
in the searching step, a portion of the time series data of the input parameters and the degradation indicator that belongs to a verification period subsequent to the training period is treated as verification data, and the optimal exponent is found by evaluating a prediction accuracy of the battery model trained using the verification data.

8. A battery degradation prediction device that calculates a predicted value of a degradation indicator for a battery according to a battery model that treats powers of a plurality of usage history parameters defined on a basis of time series data about a current, a voltage, and a temperature of the battery as explanatory variables and treats the predicted value of the degradation indicator for the battery as an objective variable, the battery degradation prediction device comprising:
a data acquirer that acquires time series data about a current, a voltage, and a temperature of the battery;
a usage history parameter calculator that calculates the usage history parameters on a basis of the time series data acquired by the data acquirer;
an input parameter generator that generates input parameters by raising the usage history parameters by an optimal exponent found by searching according to the battery model construction method according to claim 1; and
a model predictor that calculates the predicted value of the degradation indicator by inputting the input parameters into the battery model as explanatory variables, wherein
the battery model is trained with training data generated through exponentiation using the optimal exponent.

9. The battery model construction method according to claim 2, wherein the usage history parameters include current factor parameters that treat the current of the battery as a factor, voltage factor parameters that treat the voltage of the battery as a factor, and temperature factor parameters that treat the temperature of the battery as a factor.

10. The battery model construction method according to claim 9, wherein the searching step comprises searching for an optimal exponent common to the current factor parameters, the voltage factor parameters, and the temperature factor parameters.

11. The battery model construction method according to claim 9, wherein the searching step comprises searching for respectively independent optimal exponents for the current factor parameters, the voltage factor parameters, and the temperature factor parameters.

12. The battery model construction method according to claim 9, wherein the searching step comprises searching for the optimal exponent in a range from 0 to 1.

13. The battery model construction method according to claim 1, wherein in the training step, a portion of the time series data of the input parameters and the degradation indicator that belongs to a prescribed training period is treated as the training data, and
in the searching step, a portion of the time series data of the input parameters and the degradation indicator that belongs to a verification period subsequent to the training period is treated as verification data, and the optimal exponent is found by evaluating a prediction accuracy of the battery model trained using the verification data.

14. A battery degradation prediction device that calculates a predicted value of a degradation indicator for a battery according to a battery model that treats powers of a plurality of usage history parameters defined on a basis of time series data about a current, a voltage, and a temperature of the battery as explanatory variables and treats the predicted value of the degradation indicator for the battery as an objective variable, the battery degradation prediction device comprising:
a data acquirer that acquires time series data about a current, a voltage, and a temperature of the battery;
a usage history parameter calculator that calculates the usage history parameters on a basis of the time series data acquired by the data acquirer;
an input parameter generator that generates input parameters by raising the usage history parameters by an optimal exponent found by searching according to the battery model construction method according to claim 9; and
a model predictor that calculates the predicted value of the degradation indicator by inputting the input parameters into the battery model as explanatory variables, wherein
the battery model is trained with training data generated through exponentiation using the optimal exponent.
